(19) United States
(12) Patent Application Publication
(10) Pub. No.: US 2006/0033640 A1
(43) Pub. Date: Feb. 16, 2006

(54) Distrubuted radio antenna passive sensor system

(76) Inventor: Timothy Ray Minor, Belle Vernon, PA (US)

Correspondence Address: Timothy R. Minor, 503 Graham Street, Belle Vernon, PA, 15012, US

(21) Appl. No.: 10/917,078

(22) Filed: Aug. 12, 2004

(51) Int. Cl. G08B 26/00

(52) U.S. Cl. 340/870.16; 340/505

(57) ABSTRACT

A passive wireless sensor system having one or more distributed radio antennas 12 creating electromagnetic radiation paths 14 to and from the passive wireless sensors 13. The passive wireless sensors 13 are energized by a radio signal from a radio transmitter(s). The passive wireless sensors 13 are read by a radio receiver(s). The passive wireless sensors 13 convey an environmental parameter(s) to the radio receiver. Together the radio transmitter(s) and radio receiver(s) are called a central radio transmitter-receiver 11.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to passive wireless environmental sensor systems used for protection and safety of vehicles, buildings, structures, areas and/or packages.

### BACKGROUND OF THE INVENTION

The US National Aeronautics and Space Administration (NASA) employs a Thermal Protection System (TPS) to monitor the temperature of a large portion of the underside of the Space Shuttle fuselage. These are to sense extreme temperatures during re-entry into the earth's atmosphere. This TPS includes hundreds of temperature sensors, extensive electrical wiring and consumes considerable electrical power. A great amount of maintenance is required, as well.

A new TPS for the Space Shuttle is under development. This uses a system where the power for the sensors is derived from a radiated radio signal. This remote energy source is from a single radio transmitter. There is no need for electrical wiring to the individual sensors. The sensors include a small radio transmitter powered in the same way for transmitting back to a remote radio receiver. For discussion this remote energy source is called a central radio transmitter. (This can be thought of as an energizing radio transmitter.) Also for discussion, the remote radio receiver is called a central radio receiver. (This can be thought of as a reading radio receiver for the sensors.) For discussion, they can be considered to be one entity called a central radio transmitter-receiver. The temperature sensors will be called passive wireless sensors. They are called passive sensors since they do not include an active power source. They may sense one or more environmental parameters and not just temperature.

The distance that is supported between the passive wireless sensors and the central radio transmitter-receiver has certain limits. This distance is limited by transmit power and antenna size of the central radio transmitter-receiver. This distance is also limited by the antenna size and receiver sensitivity for the passive wireless sensors. Large transmit powers and/or antenna size for the central radio transmitter-receiver can employed to extend this distance or range. Doing this may present a hazard to persons in the vicinity of the sensor system.

Inventions related to this field are described in the following U.S. patents and applications:
1. U.S. Patent Application 20030144010, “Method and Apparatus for Determining Wirelessly the Position and Orientation of an Object.”; Dollinger, Franz; Jul. 31, 2003.
2. U.S. Patent Application 20040130458, “Wireless Sensors for System Monitoring and Diagnostics.”; Koutsoukas, Xenofon; et al; Jul. 8, 2004.
3. U.S. Pat. No. 6,009,356, “Wireless Transducer Data Capture and Retrieval System for Aircraft.”; Monroe, David A.; Nov. 12, 1996.
4. U.S. Pat. No. 6,720,866, “Radio Frequency Identification Tag Device With Sensor Input.”; Sorrells, Peter; et al; Apr. 13, 2004.
5. U.S. Pat. No. 6,281,794, “Radio Frequency Transponder With Improved Read Distance.”; Duan, Dah-Weih; Heinrich, Harley Kent; Aug. 28, 2001.
6. U.S. Pat. No. 6,147,606, “Apparatus and Method for Radio Frequency Transponder With Improved Read Distance.”; Duan, Dah-Weih; Nov. 14, 2000.

The current state of the art is further discussed in the following publications:
1. Hayword, G., et. al.; “Embedded Ultrasonic Transducer Design and Wireless Communications for Intelligent Monitoring of Structures”, AIP Conference Proceedings, 2003, No. 657B, pp 1623-30.
2. Ong, K. G. and Grimes, C. A.; “Tracking the Harmonic Response of Magnetically Soft Sensors for Wireless Temperature, Stress and Corrosive Monitoring”, Sensors and Activators A (Physical) (Switzerland), Sep. 30, 2002, Volume A-101, No. 1-2, pp 49-61.
3. Varadan, V. K. and Varadan, V. V.; “Wireless Surface Acoustic Wave and MEMS Based Microsensors”, Proceedings of the SPIE, Vol. 4407, 2001, pp 256-66.
4. Hausleitner, C., et al; “Low Cost Radio Interrogation Systems for Passive Saw Sensors and Transponders”, Proceedings of the 2000 12^{th} IEEE International symposium of Applications of Ferroelectrics, Vol. 2, 2001, pp 847-50.

The existing state-of-the-art for passive wireless sensor systems suffers from:
(a) inadequate distance between the passive wireless sensors and the central radio transmitter-receiver
(b) health hazards to persons in the vicinity of the system. (This is because of too great of central radio transmitter-receiver's effective radiated power.).

For the existing patents and patent applications cited, 1, 2 and 3 are not passive systems. They require a built in power source for their sensors. They do not employ or achieve the range that is possible with a distributed antenna approach. Those cited in 4, 5 and 6 do not employ or achieve the range extension that is possible with a distributed antenna approach. Those cited in 5 and 6 also do not include sensors, but are simply radio frequency identification devices. The cited published articles suffer from one or more of the same deficiencies.

### BACKGROUND OF THE INVENTION—OBJECTS AND ADVANTAGES

Objects and advantages of this invention are:
(a) significant extension of the usable range of the passive wireless sensor system
(b) alleviating hazards to persons in the vicinity of an extended range passive wireless sensor system
(c) decreased power requirements for the central radio transmitter-receiver
(d) decreased heat dissipation for the central radio transmitter-receiver
(e) increased reliability of the central radio transmitter-receiver

### SUMMARY

The invention describes a passive wireless sensor system using a distributed radio antenna(s) for energizing environmental sensors. A distributed radio antenna(s) is also used for receiving signals back from the sensors. Increased range, reduced power consumption, reduced heat dissipation, reduced human hazard, and increased reliability is achieved.

### DRAWINGS—FIGURES

FIG. 1 is a drawing of the Preferred Embodiment, “Basic Distributed Radio Antenna Passive Sensor System”.

FIG. 2 is a drawing of an Additional Embodiment, “Branched Distributed Radio Antenna Passive Sensor System”.

### DRAWINGS—Reference Numerals

11 Central Radio Transmitter-Receiver
12 Distributed Radio Antenna(s)
13 Passive Wireless Sensors
14 Electromagnetic Radiation Paths
15 Transmit Direction. (Receive is Other Direction.)
16 Radio Power Combiners-Splitters
17 And so on by logical extension ( [symbol] [symbol] [symbol] )

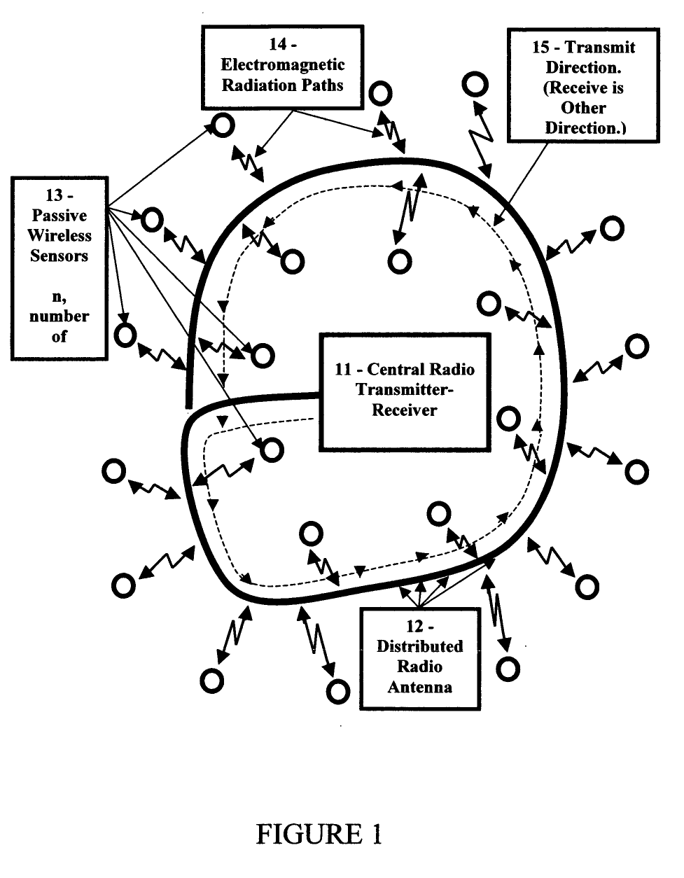

### DETAILED DESCRIPTION—PREFERRED EMBODIMENT (FIG. 1)

A preferred embodiment of the invention is shown in FIG. 1, “Basic Distributed Radio Antenna Passive Sensor System”. A Central Radio Transmitter-Receiver 11 (or transceiver) transmits and receives radio signals from a Distributed Radio Antenna 12. The Distributed Radio Antenna 12 may be realized with a radio transmission line normally used to transfer radio energy to an antenna or a radio frequency load. In this case, the transmission line (Distributed Radio Antenna 12) is intentionally not terminated with an antenna or a radio frequency load, so that radio energy is radiated from it along its' entire length. (A load termination of impedance other than the characteristic impedance of the transmission line [Distributed Radio Antenna 12] is provided. The effect is to achieve the desired degree of radiation along the transmission line.) The direction of the transmitted radio signal is labeled as “Transmit Direction. (Receive is Other Direction.)” 15. This is from the Central Radio Transmitter-Receiver 11 along the Distributed Radio Antenna 12. This is shown is shown by the dotted line with arrows 15. The direction of the received radio signal to the Central Radio Transmitter-Receiver 11 is the opposite. This is the direction for signals transmitted back from the Passive Wireless Sensors 13. This is discussed in the next paragraph.

Numerous Passive Wireless Sensors 13 can be transmitted to and received from by the Central Radio Transmitter-Receiver 11. These would normally be sensors that derive their operating energy from the Central Radio Transmitter-Receiver 11. This occurs by way of the radiation paths 14 (labeled as Electromagnetic Radiation Paths) from the Distributed Radio Antenna 12 in FIG. 1. The Passive Wireless Sensors 13 are used to detect (sense) such environmental parameters as temperature, pressure, humidity, vibration, shock and/or chemical properties. These are for portions of the structure, vehicle or area that they are located in. The Passive Wireless Sensors 13 employ a relatively low power transmitter, also powered by energy from the Central Radio Transmitter-Receiver 11. They receive the signal that is radiated from the Distributed Radio Antenna 12. They transmit their measured environmental parameter back to the Central Radio Transmitter-Receiver 11. They do this by a radio signal to the Distributed Radio Antenna 12. Any number n of Passive Wireless Sensors 13 can be used in the Distributed Antenna Passive Sensor System of FIG. 1. The Distributed Radio Antenna 12 is positioned among the Passive Wireless Sensors 13 to provide a satisfactory Electromagnetic Radiation Path 14. This positioning is chosen for a good path to each of the n Passive Wireless Sensors 13.

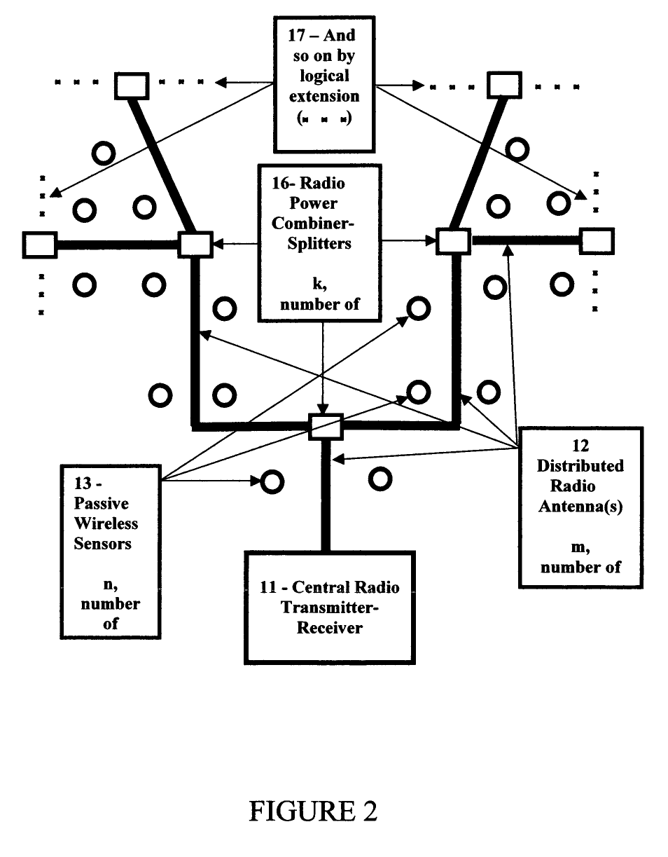

FIG. 2—Additional Embodiments

An additional embodiment of the invention is shown in FIG. 2, “Branched Distributed Radio Antenna Passive Sensor System”. In this system, the energizing radio signal for the Passive Wireless Sensors 13 is distributed by multiple Distributed Radio Antennas 12. The environmental parameter(s) back from the Passive Wireless Sensors 13 also follow the multiple Distributed Radio Antennas 12. This direction is the opposite direction of the energizing radio signal from the Central Radio Transmitter-Receiver 11. The energizing radio signal to the Passive Wireless Sensors 13 are split to each Distributed Radio Antenna 12. The signals back from the Passive Wireless sensors are combined from each Distributed Radio Antenna 12. These signals are split and combined by the Radio Power Combiner-Splitters 16. Any number k of Radio Power Splitter-Combiners 16 can be utilized. Any number m of Distributed Radio Antennas 12 can be utilized. Any number n of Passive Wireless Sensors 13 can be utilized. The Distributed Radio Antennas 12 can be oriented as necessary in the available area. This is done to facilitate adequate Electromagnetic Radiation Paths 14 to and from all of the Passive Wireless Sensors 12.

FIG. 2—Alternate Embodiments

There are various possibilities with regard to how the Passive Wireless Sensors 12 might be dispersed within a structure, vehicle or area. There are various possibilities how the Distributed Radio Antenna Branches 13 may be positioned among these sensors. More than one Centralized Radio Transmitter-Receiver 11 might be employed. The Centralized Radio Receiver-Transmitter 11 might be one or more separate transmitters and receivers. The separate transmitter(s) and receiver(s) need not be centralized or located together.

I claim:

1. The use of a distributed radio antenna in a passive wireless sensor system that is for sensing environmental parameters.

2. The use of a distributed radio antenna in a passive wireless sensor system used for environmental parameters to extend the range between the sensors and the energizing radio transmitter(s).

3. The use of a distributed radio antenna in a passive wireless sensor system used for environmental parameters to extend the range between the sensors and the reading radio receiver(s).

4. The use of a distributed radio antenna in a passive wireless sensor system used for environmental parameters to reduce the effective radiated power of the energizing radio transmitter(s).

5. The use of a distributed radio antenna in a passive wireless sensor system used for environmental parameters to reduce the antenna(s) sizes(s) of the reading radio receiver(s).
